(19) United States
(12) Patent Application Publication
(10) Pub. No.: US 2020/0065849 A1
(43) Pub. Date: Feb. 27, 2020

(54) SYSTEMS AND METHODS FOR DISCOUNTING A PRICE OF A RETAIL ITEM FOR A CUSTOMER ON A SELL BY DATE OF THE RETAIL ITEM

(71) Applicant: Walmart Apollo, LLC, Bentonville, AR (US)

(72) Inventors: Douglas J. Ryner, Cave Springs, AR (US); Patrick T. Edmunds, Lowell, AR (US)

(21) Appl. No.: 16/548,396

(22) Filed: Aug. 22, 2019

Related U.S. Application Data
(60) Provisional application No. 62/722,407, filed on Aug. 24, 2018.

(51) Int. Cl. G06Q 30/02; G06Q 20/20

(52) U.S. Cl. CPC G06Q 30/0238; G06Q 20/208

(57) ABSTRACT

In some embodiments, consumer-visible labels for indicating a discount on the full retail price of the retail item on the sell by date of the retail item are provided. The labels include a customer-visible indicator of an undiscounted price of the retail item that would be applicable prior to the sell by date, a customer-visible indicator of the sell by date of the retail item, and a customer-visible indicator showing the discount that is applicable on the sell by date of the retail item. Systems and methods for discounting a price of a retail item for a customer on a sell by date of the retail item are also provided.

### CROSS-REFERENCE TO RELATED APPLICATION

This application claims the benefit of U.S. Provisional Application No. 62/722,407, filed Aug. 24, 2018, which is incorporated herein by reference in its entirety.

### TECHNICAL FIELD

This disclosure relate generally to retail item labels and more particularly to labels, systems, and methods for discounting a price of a retail item for a customer on a sell by date of the retail item.

### BACKGROUND

Retailer facilities such as large department stores and warehouses and distribution centers associated therewith receive, stock, and transport thousands, if not millions, of units of consumer products. An individual retail item displayed on a sale floor typically includes a label attached thereto or printed thereon indicating the price of the retail item. In the case of perishable retail items, the label also includes an expiration date or use by date, which indicates the last day on which the retail item may be sold by the store and used by the customer.

Since a retail store faces the prospect of having to throw away all perishable retail items that were not purchased by consumers on or before the use by date, many retail stores discount the retail items on their use by date in order to incentivize the consumers to buy the retail items on the last day when these retail items may be sold by the retail store. To that end, the retail stores task multiple associates with physically tracking down the retail items that are expiring on a given date (e.g., by looking at a label on each perishable item in the store), and printing and attaching a new label indicating the discount applicable on that given date. A disadvantage of such a process of discounting items on their use by date is that it requires significant time commitments from many workers who could be doing other useful tasks at the retail store.

### BRIEF DESCRIPTION OF THE DRAWINGS

Disclosed herein are embodiments of systems, devices, and methods for discounting a price of a retail item for a customer on a sell by date of the retail item. This description includes drawings, wherein:

FIG. 1 is a diagram of a system of discounting a price of a retail item for a customer on a sell by date of the retail item, in accordance with some embodiments.

FIG. 2 is a simplified block diagram of a computing device, in accordance with some embodiments;

FIG. 3 shows a simplified block diagram of an exemplary worker interface device, in accordance with some embodiments; and

FIG. 4 is a flow diagram of a process of discounting a price of a retail item for a customer on a sell by date of the retail item, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common, well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems and methods of discounting a price of a retail item for a customer on a sell by date of the retail item include labeling the retail items with labels that indicate the discounted price of the retail items that would be effective on the expiration/sell by date of the retail items.

In one embodiment, a system for discounting a price of a retail item for a customer on a sell by date of the retail item includes a plurality of retail items each having a consumer-visible label thereon. The label includes: a customer-visible indicator of an undiscounted price of the retail item, the undiscounted price being effective prior to the sell by date; a customer-visible indicator of the sell by date of the retail item; and a customer-visible indicator including at least one of a discounted price of the retail item and a discount percentage off the undiscounted price of the retail item, the at least one of the discounted price and the discount percentage being effective on the sell by date of the retail item. The system further includes an electronic database configured to store the at least one of the sell by date, the undiscounted price, the discounted price, and the discount percentage associated with the retail item, and a computing device including a programmable processor. The processor is programmed to: obtain from the electronic database and in response to a scan of the label by a scanner, the sell by date of the retail item associated with the scanned label; based on a determination by the processor that the scan of the label occurred prior to the sell by date, generate an indication that the customer is to pay the undiscounted price of the retail item; and based on a determination by the processor that the scan of the label occurred on the sell by date, generate an indication that the customer is to pay the at least one of the discounted price and the discount percentage of the retail item.

In another embodiment, a method for discounting a price of a retail item for a customer on a sell by date of the retail item comprises providing a plurality of retail items each having a consumer-visible label thereon, with the label including: a customer-visible indicator of an undiscounted price of the retail item, the undiscounted price being effective prior to the sell by date; a customer-visible indicator of the sell by date of the retail item; and a customer-visible indicator including at least one of a discounted price of the retail item and a discount percentage off the undiscounted price of the retail item, the at least one of the discounted price and the discount percentage being effective on the sell by date of the retail item. The method further comprises: providing an electronic database configured to store the at least one of the sell by date, the undiscounted price, the discounted price, and the discount percentage associated with the retail item; providing a computing device including a programmable processor; obtaining, via the processor, from the electronic database and in response to a scan of the label by a scanner, the sell by date of the retail item associated with the scanned label; determining, via the processor, whether the scan of the label occurred prior to the sell by date; based on a determination by the processor that the scan of the label occurred prior to the sell by date, generating an indication that the customer is to pay the undiscounted price of the retail item; and based on a determination by the processor that the scan of the label occurred on the sell by date, generating an indication that the customer is to pay the at least one of the discounted price and the discounted percentage of the retail item.

In yet another embodiment, a consumer-visible label for discounting a price of a retail item for a customer on a sell by date of the retail item comprises: a customer-visible indicator of an undiscounted price of the retail item, the undiscounted price being effective prior to the sell by date; a customer-visible indicator of the sell by date of the retail item; and a customer-visible indicator including at least one of a discounted price of the retail item and a discount percentage off the undiscounted price of the retail item, the at least one of the discounted price and the discount percentage being effective on the sell by date of the retail item.

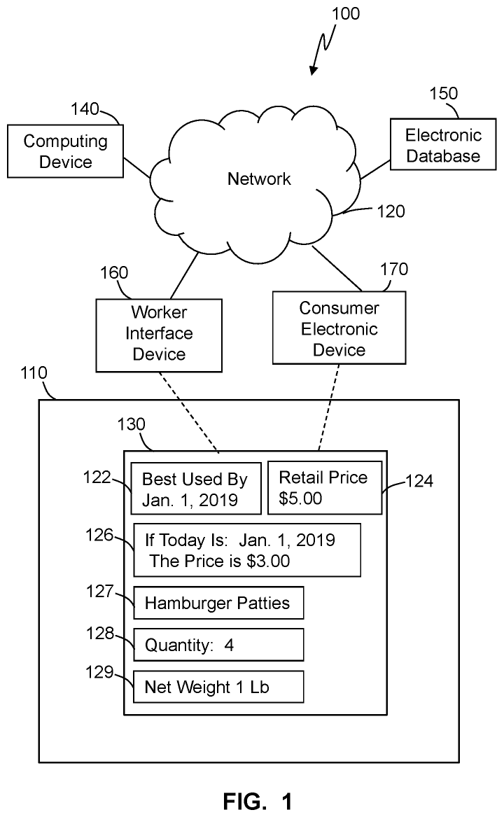

FIG. 1 shows an embodiment of a system 100 for discounting a price of a retail item 110 for a customer on a sell by date of the retail item 110. The system 100 includes a retail item 110 having a consumer-visible label 130 thereon. While only one retail item 110 is illustrated in FIG. 1 for ease of reference, it will be appreciated that the system 100 can monitor and discount any number of retail items 110 offered for sale and/or stocked in one or more retail stores. It will be understood that the term “retail item” herein refers not only to the physical consumer product itself, but may include any packaging that is associated with the retail item 110. Further, the phrase “retail item” will be understood to mean any general-purpose consumer goods (retail products and goods not for sale) and consumable products (e.g., food items, medications, or the like).

As can be seen in FIG. 1, the exemplary label 130 includes a customer-visible indicator 122 of an undiscounted price (e.g., $5.00) of the retail item 110 effective prior to the sell by date (e.g., Jan. 1, 2019) of the retail item 110, which is indicated on the label 130 via a customer-visible indicator 124 of the sell by date. In addition, the exemplary label 130 includes a customer-visible indicator 126 including a discounted price (e.g., $3.00) of the retail item 110 effective on the sell by date of the retail item 110. Since the retail item 110 includes the label 130 shown in FIG. 1, a customer interested in buying the retail item 110 would know, based on looking at the label 130, the use by date of the retail item 110, the undiscounted price of the retail item 110, and the discounted price of the retail item 110 effective on the use by date of the retail item 110.

Accordingly, if the customer is shopping at the retail store on the use by date of the retail item 110, the information regarding the use by date-associated discount displayed on the label 130 may entice the customer to purchase the retail item 110 at its discounted price of $3.00 instead of paying the full retail price of $5.00 for an identical retail item 110 that has not reached its use by date yet. If the customer does purchase the retail item 110 on its use by date, the benefit to the customer would be the $2.00 discount off the full retail price of the retail item 110, and the benefit to the retail store would include both the receipt of a payment of $3.00 for the retail item 110 from the customer, and the fact that the retail store would not have to dispatch a worker the next day to find the expired retail item 110 and throw away the unsold expired retail item 110.

While in the embodiment shown in FIG. 1, the indicator 126 of the discounted price on the label 130 lists the actual discounted price, it will be appreciated that the indicator 126 may be configured in other ways. For example, in some implementations, the indicator 126 of the label 130 may be configured to indicate the savings (i.e., discount) percentage (e.g., 50%, 40%, 30%, etc.) effective on the use by date of the retail item 110. In other aspects, the indicator 126 of the label 130 may be configured to indicate the actual dollar savings (e.g., “You Save $2.00,” “You Save 1.00,” etc.) to the customer in view of the discounted price effective on the use by date of the retail item 110.

In addition to the indicators described above, the exemplary label 130 of FIG. 1 includes an indicator 127 identifying the retail item 110 (e.g., Hamburger Patties), an indicator showing the individual consumable unit quantity (e.g., 4 patties) packaged in the retail item 110, and an indicator 129 showing the total net weight of the products packaged in the retail item 110. It will be appreciated that the above-discussed indicators are shown in FIG. 1 by way of example only, and it will be appreciated that, in some embodiments, the label 130 may not include each and every one of these indicators, and may have less (or more) indicators as appropriate for a given retail item 110. For example, in some aspects, the label 130 may include indicators including, but not limited to: an indicator showing a bar code assigned to the retail item 110, an indicator identifying the user (e.g., worker) who placed the label 130 on the retail item 110, an indicator identifying the retail store where the label 130 was generated, or the like. In addition, it will be appreciated that the label 130 has been shown in FIG. 1 as having separate and distinct indicators by way of example only, and that, in some embodiments, the label 130 may display the above-discussed information without including separate and distinct indicators.

In some embodiments, the label 130 is encoded, printed, and/or applied directly on the retail item 110 without the use of a paper (or a paper-equivalent) label. For example, the label 130 may be a digital watermark encoded on the retail item 110. In other embodiments, the label 130 may be printed on a substrate that includes an adhesive side that permits the label 130 to be attached to the retail item 110. It will be understood that the relative sizes of the label 130 and the retail item 110 are not drawn to scale, that the size of the label 130 has been exaggerated in FIG. 1 for ease of reference, and that the label 130 does not have to be necessarily placed on the retail item 110 in the location shown in FIG. 1, but may be placed on any suitable location on a front, rear, or either side of the retail item 110.

In some embodiments, the label 130 is digitally encoded directly on the retail item 110 such that the label 130 is visible to a customer (or a worker of the retail store) on the retail item 110 when the customer (or the worker) uses electronically unenhanced human vision. In other aspects, the label 130 may be digitally encoded directly on the retail item 110 such that the label 130 is visible to the customer (or the worker) on the retail item 110 only when the customer (or the worker) uses an electronic device (e.g., a consumer electronic device 170, worker interface device 160, etc.) including an optical filter. In some embodiments, the label 130 (whether encoded directly on the retail item 110 or printed on a paper label) may be polarized such that the label 130 is visible to the customer (or the worker) on the retail item 110 only when the customer (or the worker) uses polarized glasses.

With reference to FIG. 1, the exemplary system 100 of discounting a price of a retail item 110 for a customer on a sell by date of the retail item 110 includes a computing device 140 that facilitates the monitoring and discounting of the retail items 110 at the retail store. The computing device 140 of FIG. 1 may be a stationary or portable electronic device, for example, a desktop computer, a laptop computer, an electronic cash register, a tablet, a mobile phone, or any other electronic device including a processor-based control circuit (i.e., control unit). The computing device 140 may include and/or couple to one or more wired and/or wireless distributed communication network(s) 140 (e.g., wide area network (WAN), local area network (LAN), wireless local area network (WLAN), Internet, cellular, other such networks, and combinations of such networks). The computing device 140 is configured for data entry and one-way and/or two-way communication via the communication network 120 with, for example, an electronic database 150, a worker interface device 160, a consumer electronic device 170, and/or any other electronic device (e.g., regional and/or central server) located at the retail store, or remote to the retail store.

While the computing device 140 is shown in FIG. 1 as being separate from the worker interface device 160 and in communication with the worker interface device 160 via the communication network 120, it will be appreciated that the worker interface device 160 may be physically incorporated into and/or be electrically coupled (e.g., via a cable) to the computing device 140, or vice versa. For example, in embodiments, where the computing device 140 is a cash register that would be used by the customer or the retail store worker to scan the retail item 110 being purchased by the customer as well as the label 130 encoded or printed on the retail item 110, the computing device 140, the worker interface device 160 may be a scanner incorporated into and/or electrically coupled to the computing device 140.

In the embodiment shown in FIG. 1, the system 100 includes an electronic database 150 configured to store electronic information associated with the retail items 110 being displayed on the sales floor and/or stocked in the back room of the retail store, as well electronic information pertaining to the labels 130 associated with such retail items 110. The electronic database 150 may store electronic data including: unique identifiers (e.g., bar code, QR code, serial no., RFID, etc.) associated with the retail items 110, the undiscounted price of each of the retail items 110, the expiration/sell by/use by date of each of the retail items 110, the discounted price and/or discount percentage of each of the retail items 110 that would be effective on the expiration/use by date of the retail items 110, sale history (e.g., prices, dates, etc.) of the retail items 110 at the retail store, location and/or status of the retail items 110 (e.g., stored in the stock room, displayed on the sales floor, sold, expired, not expired, expiration date is today, etc.), condition of the retail items 110 (e.g., new, used, refurbished, etc.), and the like.

While the electronic database 150 is shown in FIG. 1 as being separate from the computing device 140 and in communication with the computing device 140 via the communication network 120, it will be appreciated that the electronic database 150 may be physically incorporated into and/or be electrically coupled to the computing device 140. In addition, while one electronic database 150 is shown in FIG. 1, the electronic database 150 may include two or more separate databases that are in communication with each other. The electronic database 150 may be stored, for example, on non-volatile storage media (e.g., a hard drive, flash drive, or removable optical disk) internal to or external to relative to the computing device 140. The electronic database 150 may be stored on one or more servers or may be cloud-based. In some embodiments, the electronic data stored in the electronic database 150 may be received from the computing device 140, the worker interface device 160, and/or another electronic device (e.g., consumer electronic device 170).

In the exemplary system 100 illustrated in FIG. 1, the computing device 140 is configured for two way communication with one or more worker interface devices 160 and/or one or more consumer electronic devices 170. As mentioned above, the worker interface device 160 may be incorporated into a cash register that is separate and distinct from the computing device 140 and configured for communication with the computing device 140 over the network 120. Alternatively, the worker interface device 160 may be incorporated into a computing device 140 configured to include the functionality of a cash register. As such, in some aspects, the worker interface device 160 allows a worker at a retailer facility 115 to communicate with the computing device 140 and/or the electronic database 150 to receive and/or transmit information associated with the labels 130.

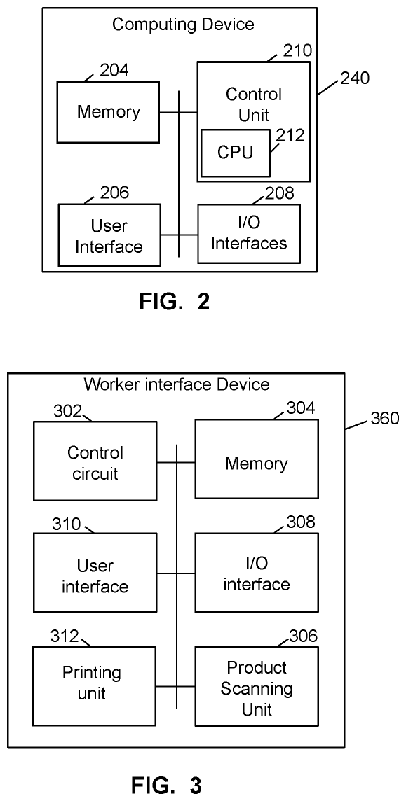

FIG. 2 shows a simplified block diagram of an exemplary computing device 240, in accordance with some embodiments. The computing device 240 includes one or more processor-based control circuits or control unit 210, memory 204, and input/output (I/O) interfaces 208. The computing device 240 also includes one or more user interfaces 206 that allows a user (e.g., a worker) to transmit signals to and receive signals from the electronic database 150, worker interface device 160, and/or consumer electronic device 170.

In some embodiments, the control unit 210 includes one or more processors and/or microprocessors. The control unit 210 couples with and/or includes the memory 204. Generally, the memory 204 stores the operational code or set of instructions that is executed by the control unit 210 and/or processor to implement the functionality of the electronic inventory management device 280. It is understood that the control unit 210 may be implemented as one or more processor devices as are well known in the art. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. In some embodiments, the control unit 210 comprises a fixed-purpose hard-wired platform or can comprise a partially or wholly programmable platform. These architectural options are well known and understood in the art and require no further description here. The control unit 210 can be configured (for example, by using corresponding programming as will be well understood by those skilled in the art) to carry out one or more of the steps, actions, and/or functions described herein.

While the memory 204 is shown as internal to the electronic inventory management device 280, the memory 204 can be internal, external or a combination of internal and external. Also, the computing device 240 may include a power supply (not shown) or it may receive power from an external source. In some instances, the control unit 210 and the memory 204 may be integrated together, such as in a microcontroller, application specification integrated circuit, field programmable gate array or other such device, or may be separate devices coupled together.

The one or more I/O interfaces 208 allow wired and/or wireless communication coupling of the electronic inventory management device 280 to external components, such as the electronic database 150, worker interface device 160, and/or consumer electronic device 170, and other such components. Accordingly, the I/O interfaces 208 may include any known wired and/or wireless interfacing device, circuit and/or connecting device. For example, in some implementations, the I/O interface 208 includes one or more transceivers, receivers, and/or transmitters that provide wireless communication in accordance with one or more wireless protocols (e.g., Wi-Fi, Bluetooth, radio frequency (RF), cellular, other such wireless communication, or combinations of such communication).

The user interface 206 of the electronic inventory management device 280 can include substantially any known input device, such one or more buttons, knobs, selectors, switches, keys, touch input surfaces and/or displays, etc. Additionally, the user interface 206 may include one or more output display devices, such as lights, visual indicators, display screens, etc. to convey to a user any information relating to expiration/use by date-related discounts of retail items 110 at the retail store. While FIG. 2 illustrates the exemplary components of the electronic inventory management device 280 being coupled together via a bus, it is understood that the components may actually be coupled to the control unit 210 and/or one or more other components directly.

In some embodiments, the processor 212 of the computing device 240 is programmed to determine the discount to be applied to a retail item 110 on the sell by date of the retail item 110. For example, the processor 212 may be programmed to determine the applicable discount based on an analysis of various factors including, but not limited to: a predetermined price discount database indicating a preset sell by date discount for each retail item 110 offered for sale at the retail store; the shelf life of the retail item 110; historical performance of sales of similar or identical retail items 110 responsive to the sell by date discount offered to the customers; historical numbers of discounted and undiscounted retail items 110 that were unsold and discarded, and the like. In some embodiments, the processor 212 may be programmed with machine learning capabilities, such that the processor 212 is enabled to update the price discount database to reflect a bigger sell by date discount, when the analysis of the applicable sell by date discount factors indicates that the sell by date discount being offered on a given retail item 110 is not effective to result in a statistically relevant increase in the sales of the retail item 110 on the sell by date. In some aspects, after the computing device 140 determines the discount price and/or discount percentage that would be applicable to the retail item 110 on the sell by date of the retail item 110, the computing device 140 transmits the determined discount price and/or discount percentage over the network 120 to the electronic database 150 for storage in association with the retail item 110.

As mentioned above, the worker interface device 160 and the consumer electronic device 170 may be in the form of any electronic device configured for wired and/or wireless communication with the computing device 140 and configured for scanning the label 130 on the retail item 110 in order to read the unique identifier and/or one or more of the indicators 122, 124, 126, 127, 128, and 129 on the label 130. In some embodiments, the label 130 of FIG. 2 may be configured such that a scan of the label 130 on a retail item 110 by the worker interface device 160 enables the worker interface device 160 to obtain electronic data representing a unique identifier of the retail item 110, after which the worker interface device 160 transmits the unique identifier of the retail item 110 obtained from the scanned label 130 to the computing device 140. In some aspects, the worker interface device 160 is configured to generate a time stamp indicating the date (e.g., Jan. 1, 2019) on which the scan of the label 130 by the worker interface device 160 occurred. In some embodiments, in addition to generating the time stamp, the worker interface device 160 is programmed to transmit the time stamp of the scan of the label 130 to the computing device 140 via the network 120.

In some aspects, in response to receiving the unique identifier of the retail item 110 scanned by the worker interface device 160 (e.g., a scanner at a cash register of a retail store), the processor 208 of the control unit 210 of the computing device 240 is programmed to obtain (e.g., by sending a query over the network 120), from the electronic database 190, the sell by date of the retail item 110 associated with the scanned label 130. In one aspect, the processor 208 causes the computing device 240 to transmit (e.g., via an I/O interface 206) a signal to the electronic database 150 including both the unique identifier obtained by the worker interface device 160 from the scanned label 130, and electronic data representing a query for the sell by date stored in the electronic database 150 in association with the retail item 110 corresponding to the unique identifier obtained from the scanned label 130.

In some embodiments, after the computing device 140 obtains (e.g., by receiving a signal over the network 120) the sell by date of the retail item 110 associated with the label 130 scanned by the worker interface device 160, the processor 208 of the control unit 210 of the computing device 140 is programmed to determine whether the scan of the label 130 occurred prior to the sell by date of the retail item 110. For example, in some aspects, the processor 212 of the computing device 240 is programmed to determine whether the date on the time stamp generated during the scan of the label 130 predates, antedates, or matches the sell by date of the retail item 110 obtained from the electronic database 150 (and displayed to the customers on the label 130 as discussed above).

In some embodiments, after the computing device 140 determines, based on the time stamp of the scan of the label 130 and the predetermined sell by date of retail item 110, that the time stamp of the scan of the label 130 predates the sell by date (i.e., the retail item 110 is being purchased by the customer from the retail store prior to its sell by date), the processor 208 of the computing device 240 is programmed to generate an indication that the customer is to pay the undiscounted price (e.g., $5.00 in the example shown in FIG. 1) of the retail item 110 (e.g., hamburger patties in the example shown in FIG. 1). Conversely, after the computing device 140 determines, based on the time stamp of the scan of the label 130 and the predetermined sell by date of retail item 110, that the time stamp of the scan of the label 130 matches the sell by date (i.e., the retail item 110 is being purchased by the customer from the retail store on the sell by date), the processor 208 of the computing device 240 is programmed to generate an indication that the customer is to pay the discounted price (e.g., $3.00 in the example shown in FIG. 1) of the retail item 110 (e.g., hamburger patties in the example illustrated in FIG. 1).

In some aspects, if the computing device 140 determines, based on the time stamp of the scan of the label 130 and the predetermined sell by date of retail item 110, that the time stamp of the scan of the label 130 antedates the sell by date (i.e., the retail item 110 is being purchased by the customer from the retail store after the retail item 110 has expired), the processor 208 of the computing device 240 is programmed to generate an alert that the customer is not permitted to purchase the retail item due to the retail item 110 being past its predetermined sell by date. The above-discussed indications and/or alerts that may be generated by the computing device 240 may be displayed to the worker of the retail store (e.g., cashier) and/or customer who is purchasing the retail item 110 via the user interface 206 of the computing device 240.

FIG. 3 shows a simplified block diagram of an exemplary worker interface device 360, in accordance with some embodiments. The worker interface device 360 includes one or more control circuits 302, memory 304, input/output (I/O) interfaces 308, and user interfaces 310. In some embodiments, the worker interface device 360 may include a product scanning unit 306 (e.g., digitally encoded label reader, barcode reader, radio frequency identification (RFID) reader, optical reader, or the like) and a printing unit 312. In some embodiments, the control circuit 302 includes one or more processors and/or microprocessors. The memory 304 stores the operational code or set of instructions that is executed by the control circuit 302 and/or processor to implement the functionality of the worker interface device 360. In some embodiments, the memory 304 may also store some or all of particular data that may be needed to make any of the associations, determinations, and/or communications described herein. Such data may be pre-stored in the memory, received from an external source (e.g., the computing device 240), be determined, and/or communicated to the user interface unit.

The control circuit 202 and/or processor may be implemented as one or more processor devices as are well known in the art. Similarly, the memory 204 may be implemented as one or more memory devices as are known in the art, such as one or more processor readable and/or computer readable media and can include volatile and/or nonvolatile media, such as RAM, ROM, EEPROM, flash memory and/or other memory technology. Further, the memory 204 is shown as internal to the worker interface device 260, but the memory 204 can be internal, external or a combination of internal and external memory. Additionally, the worker interface device 260 may include a power supply (not shown) that may be rechargeable and/or it may receive power from an external source. While FIG. 3 illustrates the components of the worker interface device 360 being coupled together via a bus, it is understood that the components of the worker interface device 360 may be coupled to the control circuit 302 and/or one or more other components directly.

Generally, the control circuit 302 and/or electronic components of the worker interface device 360 can include fixed-purpose hard-wired platforms or can comprise a partially or wholly programmable platform. These architectural options are well known and understood in the art and require no further description here. The user interface unit and/or control circuit can be configured (for example, by using corresponding programming as will be well understood by those skilled in the art) to carry out one or more of the steps, actions, and/or functions described herein. In some implementations, the control circuit 302 and the memory 304 may be integrated together, such as in a microcontroller, application specification integrated circuit, field programmable gate array or other such device, or may be separate devices coupled together.

The I/O interface 308 allows wired and/or wireless communication coupling of the worker interface device 360 to external components, such as the computing device 140 and/or the electronic database 150 shown in FIG. 1. Typically, the I/O interface 308 provides at least wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitter, receiver, transceiver, etc. The user interface 310 may be used for user input and/or output display. For example, the user interface 310 may include any known input devices, such one or more buttons, knobs, selectors, switches, keys, touch input surfaces, audio input, and/or displays, etc. Additionally, the user interface 310 may include one or more output display devices, such as lights, visual indicators, display screens, etc. to convey information relevant to the labels 130 and/or the retail items 110 to a user such as a worker at the retail store and/or to a consumer. The user interface 310 in some embodiments may also include audio systems that can receive audio commands or requests verbally issued by a user, and/or output audio content.

In some embodiments, the worker interface device 360 includes a product scanning unit 306 configured to scan a label 130 to detect at the unique identifier of the retail item 110 on which the label 130 is encoded (or to which the label 130 is attached via an adhesive). As discussed above, unique identifier on the label 130 that may be scanned by the product scanning unit 306 may include, but is not limited to: two dimensional barcode, alphanumeric characters, non-alphanumeric characters, RFID, NFC identifiers, ultra-wideband (UWB) identifiers, Bluetooth identifiers, images, digital watermarks, or other optically readable, radio frequency detectable or other such code, or combination of such codes.

The worker interface device 360 according to some embodiments may include a printing unit 312. The printing unit 312 can be configured to allow the worker interface device 360 to print one or more of the labels 130 akin to the exemplary label 130 shown in FIG. 1. In one aspect, as discussed above, the printing unit 312 is configured to generate and encode on the retail item 110 a polarized label 130 including the exemplary indicators 122, 124, 126, 127, 128, and 129, which would only be visible to the customer or a worker at the retail store if the customer or the worker are wearing polarized glasses. As mentioned above, in some aspects, the printing unit 312 prints the label 130 by digitally encoding (e.g., as a watermark) the label 130 including the exemplary indicators 122, 124, 126, 127, 128, and 129 shown in FIG. 1 directly on the retail item 110. In other aspects, the printing unit 312 prints a physical label (e.g., a paper label or the like) including the exemplary indicators 122, 124, 126, 127, 128, and 129 and having an adhesive backing, which allows the worker to fixedly (but, preferably, removably) attach the printed label 130 to the retail item 110.

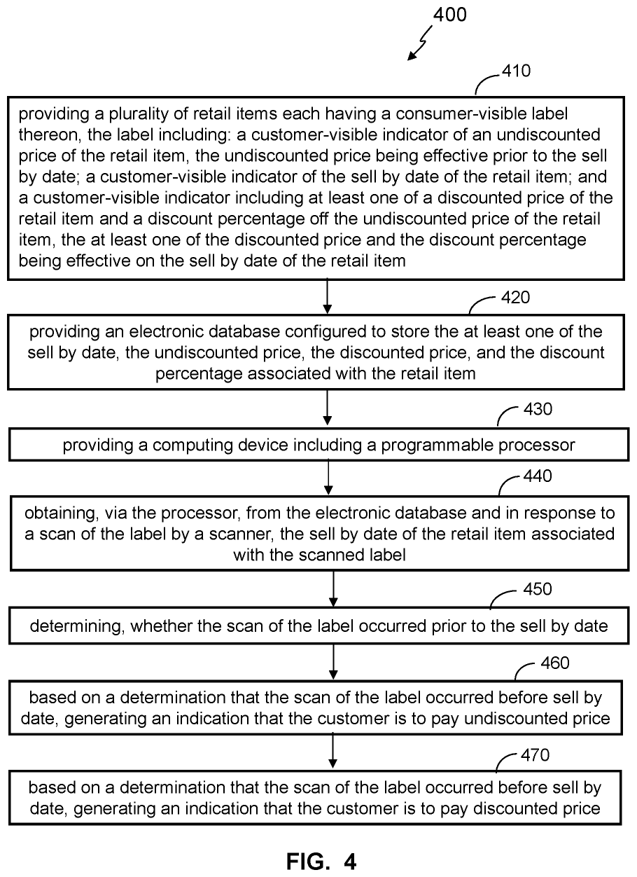

FIG. 4 illustrates a simplified flow diagram of an exemplary process 400 of a method of discounting a price of a retail item 110 for a customer on a sell by date of the retail item 100z. While the process 400 will be discussed as it applies to the exemplary system 100 shown in FIG. 1, it will be appreciated that the process 400 may be utilized in connection with any of the embodiments described herein.

The exemplary method 400 of FIG. 4 includes providing a plurality of retail items 110 each having a consumer-visible label 130 (step 410). In the embodiments illustrated in FIGS. 1 and 4, the label 130 provided on each of the retail items 110 includes multiple indicators that are visible to the customer and inform a customer as to the sell by date of the retail item 110, the full retail price of the retail item 110 that would be applicable on any day prior to the sell by date, and the discount price or discount percentage applicable to the retail item 110 on the sell by date of the retail item 110. As discussed above, the label 130 including such indicators may be encoded (e.g., by digital watermarking or the like) directly on the retail item 110 and/or printed on a physical substrate (e.g., paper or the like) having an adhesive backing that facilitates the attaching of the label 130 to the retail item 110.

In some embodiments, in addition to being visible by way of electronically unenhanced human vision, the label 130 is encoded/printed on the retail item 130 such that the label 130 is scannable by one or more electronic devices. For example, as discussed above, the worker interface device 160 (e.g., a bar code scanner, optical scanner, camera, or the like) may be used by a worker (or customer) to scan the label 130 on the retail item 130 at the point of sale register of the retail store when the customer attempts to purchase the retail item 110. Similarly, in some aspects, the consumer electronic device 170 may include a mobile app (e.g., provided by the retailer who operates the retail store or a third party) including a scanner (e.g., a bar code scanner, optical scanner, camera, or the like) that may be used by the customer to scan the label 130 on the retail item 130 to purchase the retail item 110 or to check the price of the retail item 110 that is applicable on the date of the scan of the retail item 110.

The exemplary method 400 of FIG. 4 further includes providing an electronic database 150 that is configured to store one or more of the sell by date of the retail item 110, the undiscounted price of the retail item 110 applicable on any day prior to the sell by date, the discounted price of the retail item 110 applicable on the sell by date of the retail item 110, and the discount percentage of the retail item 110 applicable on the sell by date of the retail item 110 (step 420). As discussed above, the electronic database 150 may store other electronic data in association with the retail item 110, for example, unique identifiers (e.g., bar code, QR code, serial no., RFID, etc.) associated with the retail items 110, location and/or status of the retail items 110 (e.g., stored in the stock room, displayed on the sales floor, sold, expired, not expired, expiration date is today, etc.), condition of the retail items 110 (e.g., new, used, refurbished, etc.), sale history of each of the retail items 110 (e.g., date sold, price sold, etc.), and the like.

The method 400 of FIG. 4 further includes providing a computing device 140 including a programmable processor (430). As discussed above, some of the functions of the computing device 140 include determining the price (or percentage) discount for the retail items 110 applicable on the sell by date, based on an analysis of various factors including, but not limited to: a predetermine price discount database, shelf life of the retail items 110, historical performance of sales of the retail items 110 relative to the sell by date discount offered to the customers, historical numbers of discounted and undiscounted retail items 110 that were unsold and discarded, etc. In some aspects, after the computing device 140 determines the discount price and/or discount percentage that would be applicable to the retail item 110 on the sell by date of the retail item 110, the computing device 140 transmits the determined discount price and/or discount percentage over the network 120 to the electronic database 150 for storage in association with the retail item 110.

When a retail item 110 including the label 130 is purchased at the retail store, the label 130 is scanned, for example, via the worker interface device 160 at the point of sale register, in order to obtain the unique identifier of the retail item 110 (e.g., bar code). As discussed above, in some embodiments, the worker interface device 160 may be incorporated into the computing device 140 or be in communication with the computing device 140 over the network 120. As such, in some aspects, after the label 130 of the retail item 110 is scanned via the worker interface device 160 and the unique identifier of the retail item 110 is obtained by the worker interface device 160, the worker interface device 160 transmits a signal to the computing device 140 over the network 120, with the signal including a notification that the retail item 110 has been scanned as well as the unique identifier of the retail item 110. After the computing device 140 receives such a signal from the worker interface device 160 as a result of the scan of the label 130 by the worker interface device 160, the exemplary method 400 further includes obtaining from the electronic database 150, via the processor of the computing device 140, the sell by date of the retail item 110 associated with the scanned label 130 (step 440).

After the computing device 140 obtains (e.g., by receiving a signal from the electronic database 150 over the network 120) the sell by date of the retail item 110 associated with the label 130 scanned by the worker interface device 160, the exemplary method 400 of FIG. 4 further includes determining, via the processor of the computing device 140, whether the scan of the label 130 occurred prior to the sell by date of the retail item 110 (step 450). In one aspects, the processor of the computing device 140 performs this determination by comparing a date stamp of the scan of the label 130 generated by the worker interface device 160 against the sell by date obtained by the computing device 140 from the electronic database 150. For example, in some embodiments, based upon a comparison of the date on which the label 130 is scanned and the predetermined sell by date of the retail item 110, the processor of the computing device 140 determines whether the scan date of the label 130 predates, antedates, or matches the sell by date of the retail item 110.

In particular, when the processor of the computing device 140 determines that the scan date of the label 130 predates the sell by date, the exemplary method 400 includes the computing device 140 generating an indication that the customer is to pay the undiscounted price of the retail item 110 (step 460). This indication may be generated for the customer and the worker of the retail store on an electronic display included in the user interface (see 206 in FIG. 2) of the computing device 140. Conversely, after the processor of the computing device 140 determines that the scan date of the label 130 matches the sell by date, the exemplary method 400 includes the computing device 140 generating an indication that the customer is to pay the discounted price of the retail item 110 (step 470). Notably, in some embodiments, if the processor of the computing device 140 determines that that the scan date of the label 130 is after the sell by date, the method 400 includes the computing device 140 generating an indication to the worker of the retail store and the customer that the customer may not purchase the retail item 110 (because it is expired).

The systems and methods described herein provide for labeling of products with unique labels that enable customers shopping at a retail store to see both the full retail price of the item applicable prior to the sell by date of the item, and the discount that the customer may take advantage off if the item were to be purchased on the sell by date of the item. The unique labels as described herein thus obviate the need for the retail stores to assign to their workers the daily laborious task of manually finding and relabeling items that expire on a given day. Accordingly, the systems and methods described herein advantageously improve worker efficiency at retail stores and provide for significant cost savings to the retailers operating such stores.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for discounting a price of a retail item for a customer on a sell by date of the retail item, the system comprising:
a plurality of retail items each having a consumer-visible label thereon, the label including:
a customer-visible indicator of an undiscounted price of the retail item, the undiscounted price being effective prior to the sell by date;
a customer-visible indicator of the sell by date of the retail item; and
a customer-visible indicator including at least one of a discounted price of the retail item and a discount percentage off the undiscounted price of the retail item, the at least one of the discounted price and the discount percentage being effective on the sell by date of the retail item;
an electronic database configured to store the at least one of the sell by date, the undiscounted price, the discounted price, and the discount percentage associated with the retail item;
a computing device including a programmable processor programmed to:
obtain from the electronic database and in response to a scan of the label by a scanner, the sell by date of the retail item associated with the scanned label;
based on a determination by the processor that the scan of the label occurred prior to the sell by date, generate an indication that the customer is to pay the undiscounted price of the retail item; and
based on a determination by the processor that the scan of the label occurred on the sell by date, generate an indication that the customer is to pay the at least one of the discounted price and the discount percentage of the retail item.

2. The system of claim 1, further comprising a printer configured to print the label on the retail item.

3. The system of claim 2, wherein the printer is configured to encode the label as a watermark on the retail item.

4. The system of claim 2, wherein the printer is configured to print the label on a substrate configured to be attached to the retail item.

5. The system of claim 2, wherein the printer is configured to encode the label on the retail item such that the label is visible to the customer on the retail item when the customer uses electronically unenhanced human vision.

6. The system of claim 2, wherein the printer is configured to optically encode the label on the retail item via the printer such that the label is visible to the customer on the retail item when the customer uses an electronic device including an optical filter.

7. The system of claim 2, wherein the printer is configured to polarize the label such that the label is visible to the customer on the retail item when the customer looks at the label through polarized glasses.

8. The system of claim 1, further comprising a scanner configured to scan the label and obtain an identifier of the retail item.

9. The system of claim 8, wherein the scanner is configured to generate a date stamp indicating the date on which the scan of the label occurred.

10. A method for discounting a price of a retail item for a customer on a sell by date of the retail item, the method comprising:
providing a plurality of retail items each having a consumer-visible label thereon, the label including:
a customer-visible indicator of an undiscounted price of the retail item, the undiscounted price being effective prior to the sell by date;
a customer-visible indicator of the sell by date of the retail item; and
a customer-visible indicator including at least one of a discounted price of the retail item and a discount percentage off the undiscounted price of the retail item, the at least one of the discounted price and the discount percentage being effective on the sell by date of the retail item;
providing an electronic database configured to store the at least one of the sell by date, the undiscounted price, the discounted price, and the discount percentage associated with the retail item;
providing a computing device including a programmable processor;
obtaining, via the processor, from the electronic database and in response to a scan of the label by a scanner, the sell by date of the retail item associated with the scanned label;
determining, via the processor, whether the scan of the label occurred prior to the sell by date;
based on a determination by the processor that the scan of the label occurred prior to the sell by date, generating an indication that the customer is to pay the undiscounted price of the retail item; and
based on a determination by the processor that the scan of the label occurred on the sell by date, generating an indication that the customer is to pay the at least one of the discounted price and the discounted percentage of the retail item.

11. The method of claim 10, further comprising providing a printer configured to print the label on the retail item.

12. The method of claim 10, further comprising encoding, via the printer, the label as a watermark on the retail item.

13. The method of claim 11, further comprising printing, via the printer, the label on a substrate and attaching the substrate to the retail item.

14. The method of claim 11, further comprising printing, via the printer, the label on the retail item such that the label is visible to the customer on the retail item when the customer uses electronically unenhanced human vision.

15. The method of claim 11, further comprising optically encoding the label on the retail item via the printer such that the label is visible to the customer on the retail item when the customer uses an electronic device including an optical filter.

16. The method of claim 11, further comprising polarizing the label via the printer such that the label is visible to the customer on the retail item when the customer looks at the label through polarized glasses.

17. The method of claim 10, further comprising providing a scanner configured to scan the label and obtain an identifier of the retail item.

18. The method of claim 17, further comprising generating, via the scanner, a date stamp indicating the date on which the scan of the label occurred.

19. A consumer-visible label for discounting a price of a retail item for a customer on a sell by date of the retail item, the label comprising:
a customer-visible indicator of an undiscounted price of the retail item, the undiscounted price being effective prior to the sell by date;
a customer-visible indicator of the sell by date of the retail item; and
a customer-visible indicator including at least one of a discounted price of the retail item and a discount percentage off the undiscounted price of the retail item, the at least one of the discounted price and the discount percentage being effective on the sell by date of the retail item.
